(19) United States
(12) Patent Application Publication
(10) Pub. No.: US 2025/0273903 A1
(43) Pub. Date: Aug. 28, 2025

(54) Female Connector

(71) Applicants: Dongguan Tarng Yu Electronics Co., Ltd., Dongguan City (CN); Tarng Yu Enterprise Co., Ltd., New Taipei City (TW)

(72) Inventors: TSUNG-CHI CHEN, New Taipei City (TW); MU-JUNG HUANG, New Taipei City (TW)

(21) Appl. No.: 19/062,321

(22) Filed: Feb. 25, 2025

(30) Foreign Application Priority Data
Feb. 26, 2024 (TW) 113201959

(51) Int. Cl. H01R 13/629; H01R 13/40

(52) U.S. Cl. CPC H01R 13/629; H01R 13/40

(57) ABSTRACT

A female connector, wherein the female connector is provided to allow insertion of a male connector in the inserting direction. The insulation core of the female connector comprises an inserting guiding structure, which provides interference when the male connector is inserted in an incorrect inserting direction to prevent incorrect insertion of the male connector into the female connector, thereby enabling the male connector to be inserted into the female connector for power or signal transmission.

### CROSS-REFERENCE TO RELATED APPLICATIONS

This application claims the priority of Republic of China Patent Application No. 113201959 filed on Feb. 26, 2024, in the State Intellectual Property Office of the R.O.C., the disclosure of which is incorporated herein by reference.

### BACKGROUND OF THE INVENTION

### Field of the Invention

This application relates to signal transmission technology, and more specifically, to a female connector that can prevent incorrect inserting direction of a male connector.

### Descriptions of the Related Art

In electrical equipment, it is often necessary to transmit electrical signals through a connector assembly composed of a female connector and a male connector. During the implementation of the connector assembly, the male connector can be inserted into the female connector to provide electrical signal transmission for the electrical equipment.

However, the inserting of the male connector into the female connector is usually directional. If the inserting direction of the male connector is incorrect, the electrical signal transmission of the connector assembly may suffer from voltage mismatches and other issues, thereby causing the electrical equipment to malfunction.

Therefore, how to provide a female connector that prevents incorrect inserting direction of the male connector is indeed an urgent problem to be solved by those skilled in the relevant technical field.

### SUMMARY OF THE INVENTION

In view of the drawbacks of the prior art mentioned above, the present application provides a female connector, wherein the female connector is provided to allow insertion of a male connector in an inserting direction, the female connector comprising: a female conductive terminal set, wherein the female conductive terminal set comprises a first female terminal, a second female terminal, a third female terminal, and a fourth female terminal; and a female insulation core, wherein the female insulation core comprises a first female core lateral outer wall, a second female core lateral outer wall, a first female core longitudinal outer wall, a second female core longitudinal outer wall, a first female core lateral inner wall, a second female core lateral inner wall, and a first female core longitudinal inner wall; wherein, the first female core lateral outer wall and the second female core lateral outer wall extend laterally, respectively, and the first female core longitudinal outer wall and the second female core longitudinal outer wall extend longitudinally, respectively; the first female core longitudinal outer wall is connected to the first female core lateral outer wall, and the second female core longitudinal outer wall is connected to the second female core lateral outer wall to form a female core major internal inserting space; the first female core lateral inner wall and the second female core lateral inner wall extend laterally, respectively, wherein the first female core lateral inner wall is connected to the first female core longitudinal outer wall to form a first female major inserting guiding structure, and the first female core longitudinal inner wall is connected to the first female core lateral outer wall, the second female core lateral outer wall, and the second female core lateral inner wall to form a second female major inserting guiding structure, wherein, the first female major inserting guiding structure and the second female major inserting guiding structure partition the female core major internal inserting space into a first female major internal inserting subspace, a second female major internal inserting subspace, a third female major internal inserting subspace, and a fourth female major internal inserting subspace; the female insulation core is respectively mated with the first female terminal, the second female terminal, the third female terminal, and the fourth female terminal, allowing the first female terminal, the second female terminal, the third female terminal, and the fourth female terminal to respectively extend into the first female major internal inserting subspace, the second female major internal inserting subspace, the third female major internal inserting subspace, and the fourth female major internal inserting subspace; and the first female major internal inserting subspace is in continuity with the second female major internal inserting subspace, and the third female major internal inserting subspace is in continuity with the fourth female major internal inserting subspace to guide the inserting of the male connector in the inserting direction, enabling the male connector to respectively enter the first female major internal inserting subspace, the second female major internal inserting subspace, the third female major internal inserting subspace, and the fourth female major internal inserting subspace and be inserted into the first female terminal, the second female terminal, the third female terminal, and the fourth female terminal, respectively.

Preferably, the female connector said above, wherein the first female major inserting guiding structure comprises a T-shaped cross-section; and the second female major inserting guiding structure comprises a T-shaped cross-section.

Preferably, the female connector said above, wherein the first female core lateral inner wall and the first female core longitudinal outer wall are substantially perpendicularly intersected, and the second female core lateral inner wall and the first female core longitudinal inner wall are substantially perpendicularly intersected.

Preferably, the female connector said above, wherein the female insulation core comprises a lateral extension plane, the first female core lateral inner wall and the second female core lateral inner wall extend along the lateral extension plane, and the lateral extension plane is substantially perpendicularly intersected with the first female core longitudinal outer wall and the first female core longitudinal inner wall.

Preferably, the female connector said above, wherein the female conductive terminal set further comprises a fifth female terminal and a sixth female terminal, and the female insulation core further comprises a third female core longitudinal outer wall and a third female core lateral inner wall, wherein the third female core longitudinal outer wall extends longitudinally and is respectively connected to the first female core lateral outer wall and the second female core lateral outer wall, thereby forming a female core minor internal inserting space; the third female core lateral inner wall is connected to the second female core longitudinal outer wall or the third female core longitudinal outer wall to form a first female minor inserting guiding structure; wherein, the first female minor inserting guiding structure partitions the female core minor internal inserting space into a first female minor internal inserting subspace and a second female minor internal inserting subspace; the female insulation core is further mated with the fifth female terminal and the sixth female terminal, allowing the fifth female terminal and the sixth female terminal to respectively extend into the first female minor internal inserting subspace and the second female minor internal inserting subspace; and the first female minor internal inserting subspace is in continuity with the second female minor internal inserting subspace to guide the insertion of the male connector in the inserting direction, enabling the male connector to respectively enter the first female minor internal inserting subspace and the second female minor internal inserting subspace and be inserted into the fifth female terminal and the sixth female terminal, respectively.

Preferably, the female connector said above, wherein the first female minor inserting guiding structure comprises a T-shaped cross-section.

Preferably, the female connector said above, wherein the third female core lateral inner wall and the second female core longitudinal outer wall or the third female core longitudinal outer wall are substantially perpendicularly intersected.

Preferably, the female connector said above, wherein the female insulation core comprises a lateral extension plane, the first female core lateral inner wall, the second female core lateral inner wall, and the third female core lateral inner wall extend along the lateral extension plane, and the lateral extension plane is substantially perpendicularly intersected with the first female core longitudinal outer wall, the first female core longitudinal inner wall, the second female core longitudinal outer wall, and the third female core longitudinal outer wall.

Preferably, the female connector said above, wherein the female conductive terminal set further comprises a fifth female terminal and a sixth female terminal, and the female insulation core further comprises a third female core longitudinal outer wall, wherein the third female core longitudinal outer wall extends longitudinally and is respectively connected to the first female core lateral outer wall and the second female core lateral outer wall, thereby forming a female core minor internal inserting space; wherein, the female insulation core is further mated with the fifth female terminal and the sixth female terminal, allowing the fifth female terminal and the sixth female terminal to respectively extend into the female core minor internal inserting space; and the female core minor internal inserting space guides the insertion of the male connector in the inserting direction, enabling the male connector to enter the female core minor internal inserting space and be inserted into the fifth female terminal and the sixth female terminal.

Compared to the prior art, the present application provides a female connector, which allows a male connector to be inserted in the inserting direction. The core of the female connector an inserting guiding structure, which provides interference when the male connector is inserted in the wrong inserting direction, thereby preventing the male connector from being inserted into the female connector in the wrong direction. This ensures that the male connector can be inserted into the female connector to facilitate power or signal transmission.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a three-dimensional schematic view of the female connector of the present application in an embodiment.

FIG. 2 is a front schematic view of the female connector of the present application in an embodiment.

FIG. 3 is a front schematic view of the female connector of the present application in an embodiment.

FIG. 4 is a front schematic view of the female connector of the present application in an embodiment.

FIG. 5 is a front schematic view of the female connector of the present application in an embodiment.

FIG. 6 is a sectional schematic view of a partial component of the female connector shown in FIG. 4, taken along line AA.

FIG. 7 is a sectional schematic view of a partial component of the female connector shown in FIG. 4, taken along line BB.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

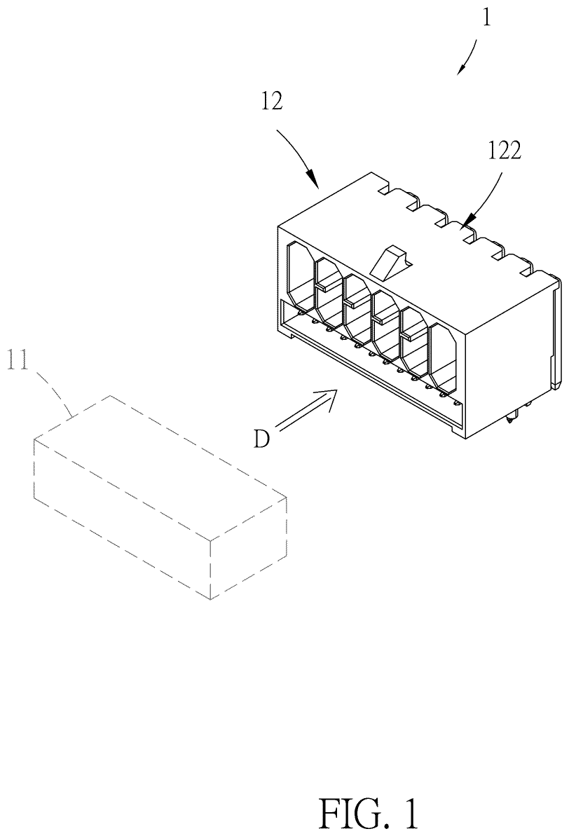

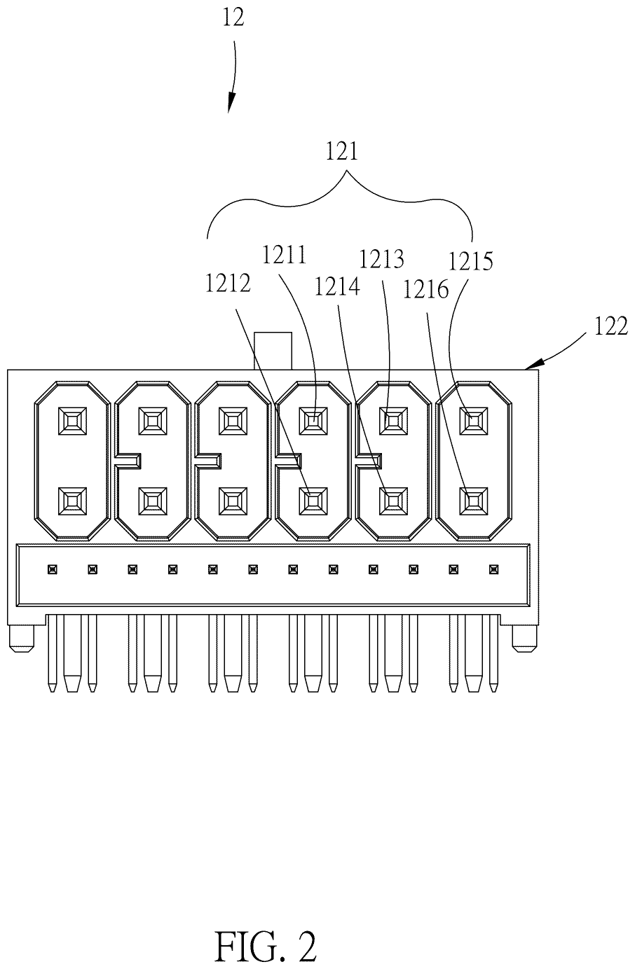

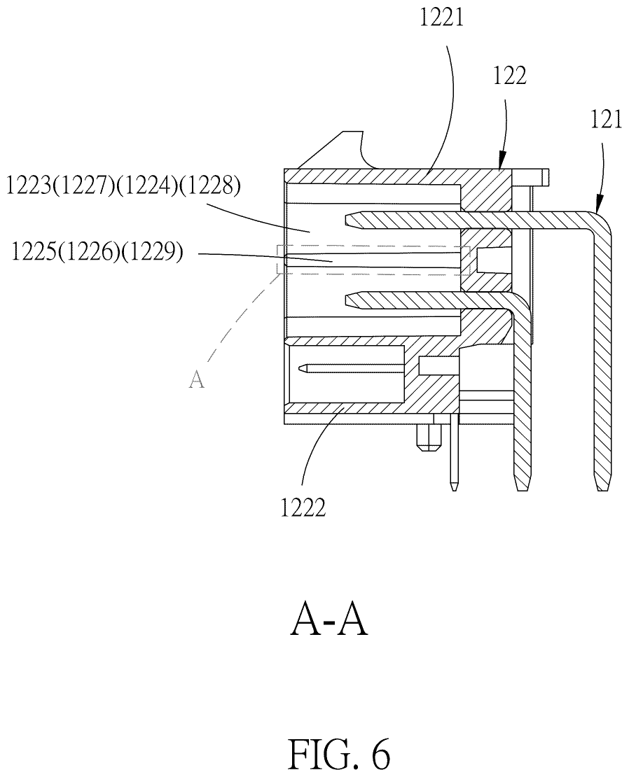

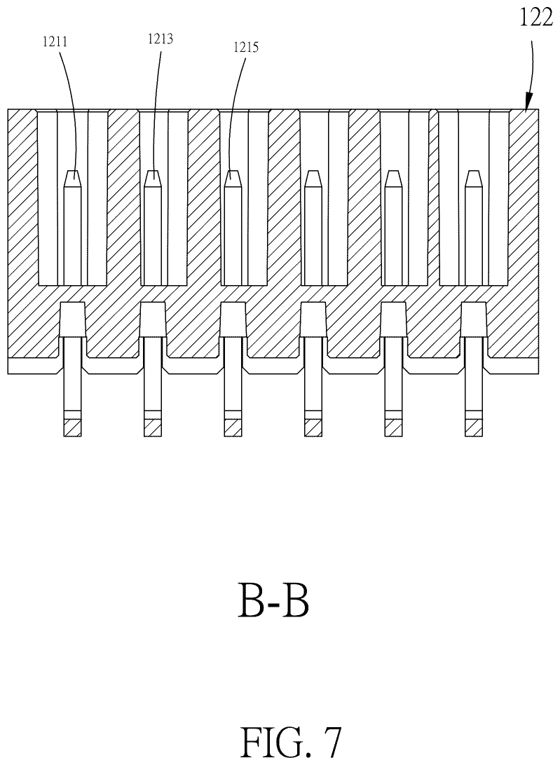

For a detailed description of the embodiments disclosed in the present application, please refer to FIGS. 1 to 7.

The present application provides at least one connector assembly 1 that can be installed in electrical equipment, wherein the connector assembly 1 comprises a male connector 11 and a female connector 12. The male connector 11 can be inserted into the female connector 12 in an inserting direction D to provide power or signal transmission for the electrical equipment.

In the embodiments shown in FIGS. 1, 2, and 5, the female connector 12 comprises a female conductive terminal set 121 and a female insulation core 122. The female conductive terminal set 121 comprises a first female terminal 1211, a second female terminal 1212, a third female terminal 1213, a fourth female terminal 1214, a fifth female terminal 1215, and a sixth female terminal 1216, which provide power or signal transmission. The female insulation core 122 comprises a first female core lateral outer wall 1221, a second female core lateral outer wall 1222, a first female core longitudinal outer wall 1223, a second female core longitudinal outer wall 1224, a first female core lateral inner wall 1225, a second female core lateral inner wall 1226, a first female core longitudinal inner wall 1227, a third female core longitudinal outer wall 1228, and a third female core lateral inner wall 1229.

In the above embodiment, the first female core lateral outer wall 1221 and the second female core lateral outer wall 1222 respectively extend laterally, while the first female core longitudinal outer wall 1223, the second female core longitudinal outer wall 1224, and the third female core longitudinal outer wall 1228 respectively extend longitudinally. The first female core lateral inner wall 1225, the second female core lateral inner wall 1226, and the third female core lateral inner wall 1229 respectively extend laterally.

Additionally, the first female core longitudinal outer wall 1223 is connected to the first female core lateral outer wall 1221, and the second female core longitudinal outer wall 1224 is connected to the second female core lateral outer wall 1222, enabling the first female core longitudinal outer wall 1223, the second female core longitudinal outer wall 1224, the first female core lateral outer wall 1221, and the second female core lateral outer wall 1222 to form a female core major internal inserting space S1. The third female core longitudinal outer wall 1228 is respectively connected to the first female core lateral outer wall 1221 and the second female core lateral outer wall 1222, enabling the second female core longitudinal outer wall 1224, the third female core longitudinal outer wall 1228, the first female core lateral outer wall 1221, and the second female core lateral outer wall 1222 to form a female core minor internal inserting space S2.

It should be noted that the male connector 11 can be inserted into the female connector 12 in the female core major internal inserting space S1 and the female core minor internal inserting space S2.

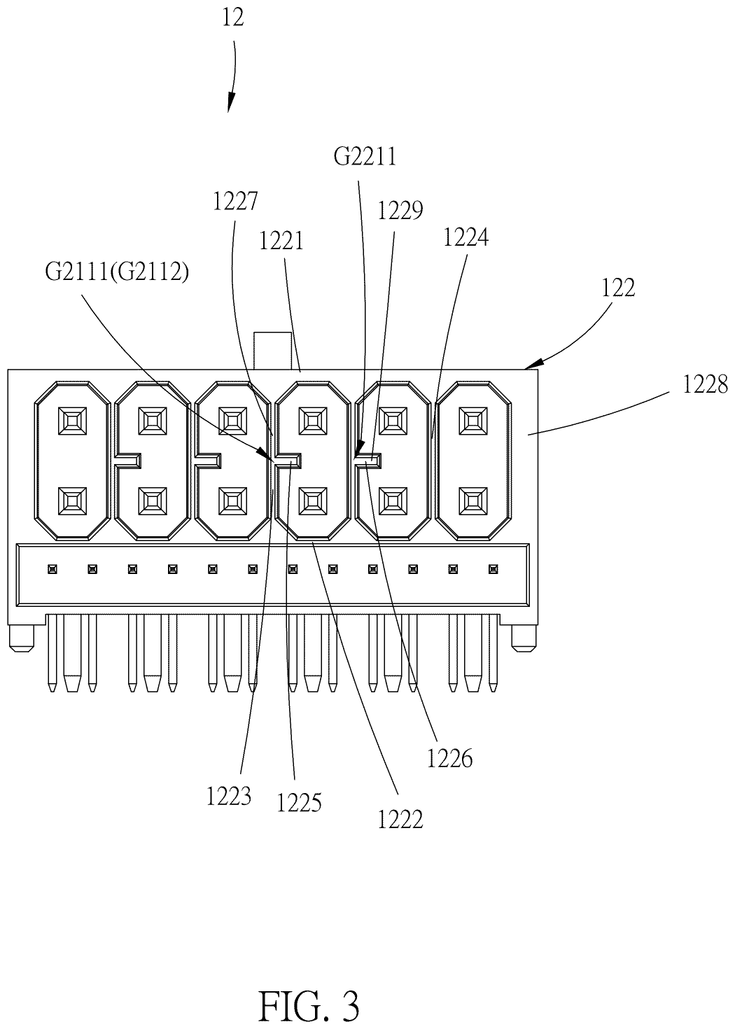

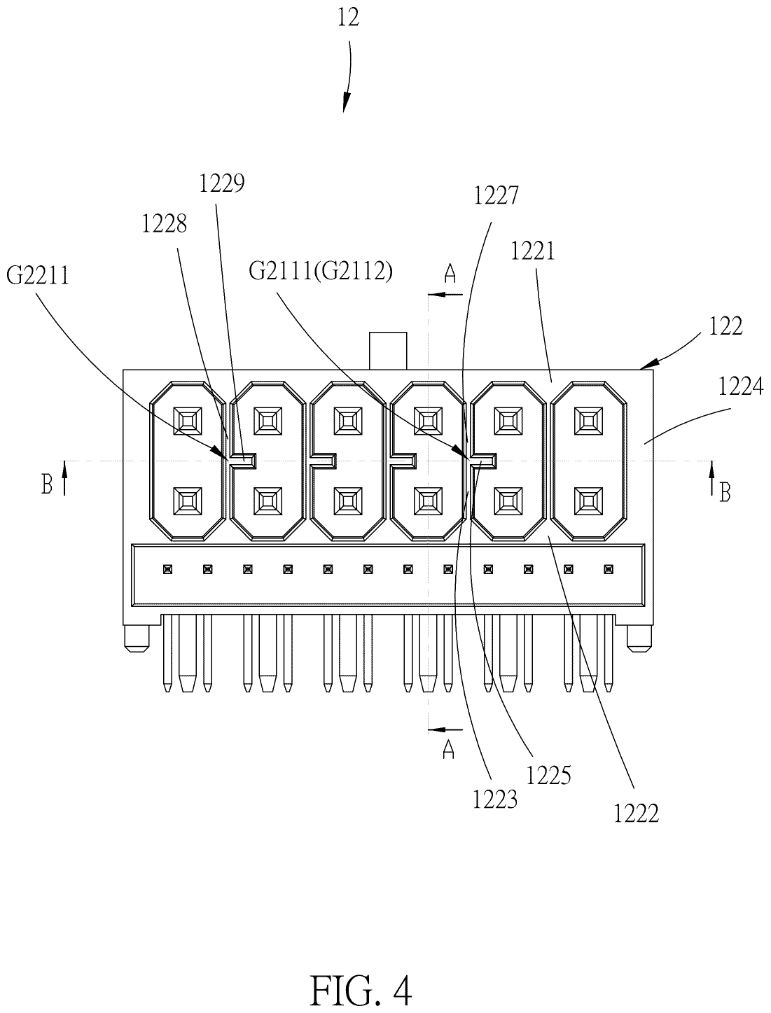

Additionally, the first female core lateral inner wall 1225 is connected to the first female core longitudinal outer wall 1223, enabling the first female core lateral inner wall 1225 and the first female core longitudinal outer wall 1223 to form a first female major inserting guiding structure G2111. The first female core longitudinal inner wall 1227 is respectively connected to the first female core lateral outer wall 1221, the second female core lateral outer wall 1222, and the second female core lateral inner wall 1226, enabling the first female core longitudinal inner wall 1227 and the second female core lateral inner wall 1226 to form a second female major inserting guiding structure G2112. As shown in FIG. 3, the third female core lateral inner wall 1229 is connected to the second female core longitudinal outer wall 1224, enabling the third female core lateral inner wall 1229 and the second female core longitudinal outer wall 1224 to form a first female minor inserting guiding structure G2211. As shown in FIG. 4, the third female core lateral inner wall 1229 is connected to the third female core longitudinal outer wall 1228, enabling the third female core lateral inner wall 1229 and the third female core longitudinal outer wall 1228 to form a first female minor inserting guiding structure G2211.

In the above embodiment, the first female major inserting guiding structure G2111 and the second female major inserting guiding structure G2112 partition the female core major internal inserting space S1 into a first female major internal inserting subspace S11, a second female major internal inserting subspace S12, a third female major internal inserting subspace S13, and a fourth female major internal inserting subspace S14. The first female major internal inserting subspace S11 is in continuity with the second female major internal inserting subspace S12, providing guidance for the insertion of the male connector 11 in the inserting direction D. The third female major internal inserting subspace S13 is in continuity with the fourth female major internal inserting subspace S14, also providing guidance for the insertion of the male connector 11 in the inserting direction D. This allows the male connector 11 to be inserted into the female connector 12, enabling the male connector 11 respectively to enter the first female major internal inserting subspace S11, the second female major internal inserting subspace S12, the third female major internal inserting subspace S13, and the fourth female major internal inserting subspace S14, respectively being inserted with the first female terminal 1211, the second female terminal 1212, the third female terminal 1213, and the fourth female terminal 1214 to provide power or signal transmission for the electrical equipment.

Additionally, the first female minor inserting guiding structure G2211 partitions the female core minor internal inserting space S2 into a first female minor internal inserting subspace S21 and a second female minor internal inserting subspace S22. The first female minor internal inserting subspace S21 is in continuity with the second female minor internal inserting subspace S22, providing guidance for the insertion of the male connector 11 in the inserting direction D. This allows the male connector 11 to be inserted into the female connector 12 and enter the first female minor internal inserting subspace S21 and the second female minor internal inserting subspace S22, respectively being inserted with the fifth female terminal 1215 and the sixth female terminal 1216 to provide power or signal transmission for the electrical equipment.

The female insulation core 122 mates with and positions the first female terminal 1211, the second female terminal 1212, the third female terminal 1213, the fourth female terminal 1214, the fifth female terminal 1215, and the sixth female terminal 1216, ensuring that the first female terminal 1211, the second female terminal 1212, the third female terminal 1213, the fourth female terminal 1214, the fifth female terminal 1215 remain separated and extend into the first female major internal inserting subspace S11, the second female major internal inserting subspace S12, the third female major internal inserting subspace S13, the fourth female major internal inserting subspace S14, the first female minor internal inserting subspace S21, and the second female minor internal inserting subspace S22, respectively.

It should be noted that when the male connector 11 is inserted into the female connector 12 in the inserting direction D, the first female major inserting guiding structure G2111, the second female major inserting guiding structure G2112, and the first female minor inserting guiding structure G2211 provide guidance for the insertion of the male connector 11 in the inserting direction D. This ensures that the male connector 11 respectively enters the first female major internal inserting subspace S11, the second female major internal inserting subspace S12, the third female major internal inserting subspace S13, the fourth female major internal inserting subspace S14, the first female minor internal inserting subspace S21, and the second female minor internal inserting subspace S22, respectively being inserted with the first female terminal 1211, the second female terminal 1212, the third female terminal 1213, the fourth female terminal 1214, the fifth female terminal 1215, and the sixth female terminal 1216 to provide power or signal transmission for the electrical equipment.

In the embodiment shown in FIGS. 3 to 4, the first female major inserting guiding structure G2111 comprises a T-shaped cross-section that can form a foolproof structure; the second female major inserting guiding structure G2112 comprises a T-shaped cross-section that can form a foolproof structure and constitutes a foolproof structure; and the first female minor inserting guiding structure G2211 comprises a T-shaped cross-section that can form a foolproof structure. In this way, through the foolproof structures mentioned above, interference is provided when the inserting direction D of the male connector 11 is incorrect, thereby preventing the male connector 11 from being inserted into the female connector 12 in the wrong direction.

Additionally, in the embodiment shown in FIGS. 3 to 4, the first female core lateral inner wall 1225 and the first female core longitudinal outer wall 1223 are substantially perpendicularly intersecting to form a foolproof structure; the second female core lateral inner wall 1226 and the first female core longitudinal inner wall 1227 are substantially perpendicularly intersecting to form a foolproof structure; and the third female core lateral inner wall 1229 and either the second female core longitudinal outer wall 1224 or the third female core longitudinal outer wall 1228 are substantially perpendicularly intersecting to form a foolproof structure. In this way, through the foolproof structures mentioned above, interference is provided when the inserting direction D of the male connector 11 is incorrect, thereby preventing the male connector 11 from being inserted into the female connector 12 in the wrong direction.

Furthermore, the female insulation core 122 comprises a lateral extension plane A, and the first female core lateral inner wall 1225, the second female core lateral inner wall 1226, and the second female core lateral inner wall 1226 extend respectively along the lateral extension plane A to form a foolproof structure. Additionally, the first female core longitudinal outer wall 1223, the first female core longitudinal inner wall 1227, the second female core longitudinal outer wall 1224, and the third female core longitudinal outer wall 1228 are respectively and substantially perpendicularly intersecting with the lateral extension plane A to form a foolproof structure. In this way, through the foolproof structures mentioned above, interference is provided when the inserting direction D of the male connector 11 is incorrect, thereby preventing the male connector 11 from being inserted into the female connector 12 in the wrong direction.

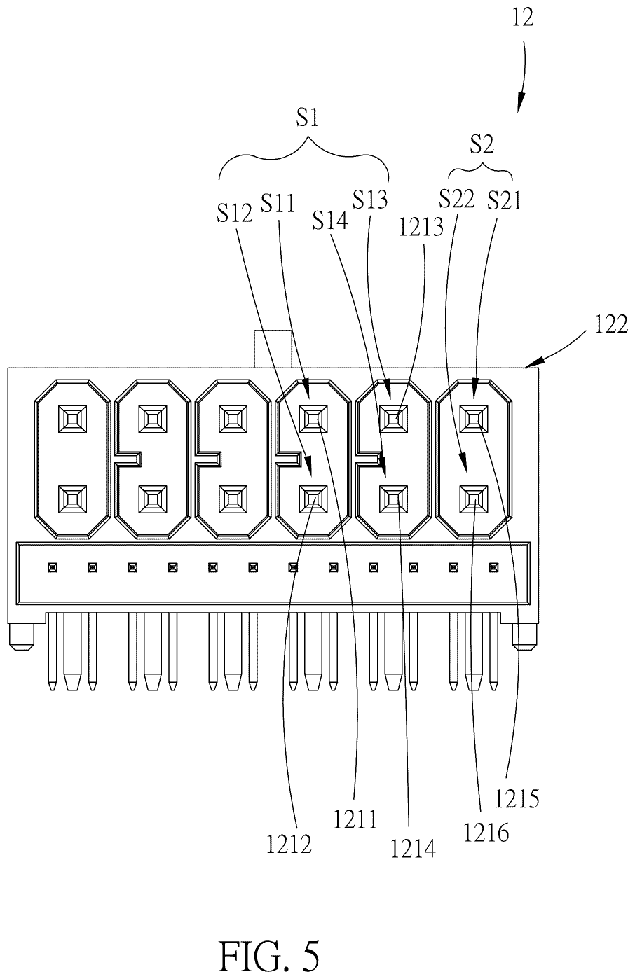

In the embodiment shown in FIG. 5, the third female core lateral inner wall 1229 can be omitted, thereby allowing the second female core longitudinal outer wall 1224, the third female core longitudinal outer wall 1228, the first female core lateral outer wall 1221, and the second female core lateral outer wall 1222 to form a female core minor internal inserting space S2. It should be noted that the female core minor internal inserting space S2 can provide guidance for the insertion of the male connector 11 in the inserting direction D, allowing the male connector 11 to enter the female core minor internal inserting space S2 and insert into the fifth female terminal 1215 and the sixth female terminal 1216.

It should be noted that the above embodiments of the connector assembly and its female connector in this application can also omit some components. For example, the female connector may optionally comprise only the female conductive terminal set and the female insulation core. The female conductive terminal set comprises a first female terminal, a second female terminal, a third female terminal, and a fourth female terminal. The female insulation core comprises a first female core lateral outer wall, a second female core lateral outer wall, a first female core longitudinal outer wall, a second female core longitudinal outer wall, a first female core lateral inner wall, a second female core lateral inner wall, and a first female core longitudinal inner wall. The first female core lateral outer wall and the second female core lateral outer wall respectively extend laterally, while the first female core longitudinal outer wall and the second female core longitudinal outer wall respectively extend longitudinally. The first female core longitudinal outer wall and the second female core longitudinal outer wall are respectively connected with the first female core lateral outer wall and the second female core lateral outer wall to form a female core major internal inserting space. The first female core lateral inner wall and the second female core lateral inner wall extend laterally. The first female core lateral inner wall is in continuity with the first female core longitudinal outer wall to form the first female major inserting guiding structure, and the first female core longitudinal inner wall is in continuity with the first female core lateral outer wall, the second female core lateral outer wall, and the second female core lateral inner wall to form the second female major inserting guiding structure. The first female major inserting guiding structure and the second female major inserting guiding structure partition the female core major internal inserting space into a first female major internal inserting subspace, a second female major internal inserting subspace, a third female major internal inserting subspace, and a fourth female major internal inserting subspace. The female insulation core is respectively mated with the first female terminal, the second female terminal, the third female terminal, and the fourth female terminal, such that the first female terminal, the second female terminal, the third female terminal, and the fourth female terminal respectively extend into the first female major internal inserting subspace, the second female major internal inserting subspace, the third female major internal inserting subspace, and the fourth female major internal inserting subspace. The first female major internal inserting subspace is in continuity with the second female major internal inserting subspace, and the third female major internal inserting subspace is in continuity with the fourth female major internal inserting subspace, thereby providing guidance for the insertion of the male connector in the inserting direction, allowing the male connector to respectively enter the first female major internal inserting subspace, the second female major internal inserting subspace, the third female major internal inserting subspace, and the fourth female major internal inserting subspace and respectively insert into the first female terminal, the second female terminal, the third female terminal, and the fourth female terminal.

In summary, this application provides a female connector that allows for the insertion of a male connector in the inserting direction. The insulation core of the female connector comprises an inserting guiding structure, which provides interference when the inserting direction of the male connector is incorrect, thereby preventing the male connector from being inserted into the female connector in the wrong direction. This allows the male connector to be inserted into the female connector to facilitate power or signal transmission.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. A female connector, wherein the female connector is provided to allow insertion of a male connector in an inserting direction, the female connector comprising:
a female conductive terminal set, wherein the female conductive terminal set comprises a first female terminal, a second female terminal, a third female terminal, and a fourth female terminal; and
a female insulation core, wherein the female insulation core comprises a first female core lateral outer wall, a second female core lateral outer wall, a first female core longitudinal outer wall, a second female core longitudinal outer wall, a first female core lateral inner wall, a second female core lateral inner wall, and a first female core longitudinal inner wall; wherein,
the first female core lateral outer wall and the second female core lateral outer wall extend laterally, respectively, and the first female core longitudinal outer wall and the second female core longitudinal outer wall extend longitudinally, respectively; the first female core longitudinal outer wall is connected to the first female core lateral outer wall, and the second female core longitudinal outer wall is connected to the second female core lateral outer wall to form a female core major internal inserting space;
the first female core lateral inner wall and the second female core lateral inner wall extend laterally, respectively, wherein the first female core lateral inner wall is connected to the first female core longitudinal outer wall to form a first female major inserting guiding structure, and the first female core longitudinal inner wall is connected to the first female core lateral outer wall, the second female core lateral outer wall, and the second female core lateral inner wall to form a second female major inserting guiding structure, wherein,
the first female major inserting guiding structure and the second female major inserting guiding structure partition the female core major internal inserting space into a first female major internal inserting subspace, a second female major internal inserting subspace, a third female major internal inserting subspace, and a fourth female major internal inserting subspace;
the female insulation core is respectively mated with the first female terminal, the second female terminal, the third female terminal, and the fourth female terminal, allowing the first female terminal, the second female terminal, the third female terminal, and the fourth female terminal to respectively extend into the first female major internal inserting subspace, the second female major internal inserting subspace, the third female major internal inserting subspace, and the fourth female major internal inserting subspace; and
the first female major internal inserting subspace is in continuity with the second female major internal inserting subspace, and the third female major internal inserting subspace is in continuity with the fourth female major internal inserting subspace to guide the inserting of the male connector in the inserting direction, enabling the male connector to respectively enter the first female major internal inserting subspace, the second female major internal inserting subspace, the third female major internal inserting subspace, and the fourth female major internal inserting subspace and be inserted into the first female terminal, the second female terminal, the third female terminal, and the fourth female terminal, respectively.

2. The female connector of claim 1, wherein the first female major inserting guiding structure comprises a T-shaped cross-section; and the second female major inserting guiding structure comprises a T-shaped cross-section.

3. The female connector of claim 1, wherein the first female core lateral inner wall and the first female core longitudinal outer wall are substantially perpendicularly intersected, and the second female core lateral inner wall and the first female core longitudinal inner wall are substantially perpendicularly intersected.

4. The female connector of claim 1, wherein the female insulation core comprises a lateral extension plane, the first female core lateral inner wall and the second female core lateral inner wall extend along the lateral extension plane, and the lateral extension plane is substantially perpendicularly intersected with the first female core longitudinal outer wall and the first female core longitudinal inner wall.

5. The female connector of claim 1, wherein the female conductive terminal set further comprises a fifth female terminal and a sixth female terminal, and the female insulation core further comprises a third female core longitudinal outer wall and a third female core lateral inner wall, wherein the third female core longitudinal outer wall extends longitudinally and is respectively connected to the first female core lateral outer wall and the second female core lateral outer wall, thereby forming a female core minor internal inserting space;
the third female core lateral inner wall is connected to the second female core longitudinal outer wall or the third female core longitudinal outer wall to form a first female minor inserting guiding structure; wherein,
the first female minor inserting guiding structure partitions the female core minor internal inserting space into a first female minor internal inserting subspace and a second female minor internal inserting subspace;
the female insulation core is further mated with the fifth female terminal and the sixth female terminal, allowing the fifth female terminal and the sixth female terminal to respectively extend into the first female minor internal inserting subspace and the second female minor internal inserting subspace; and
the first female minor internal inserting subspace is in continuity with the second female minor internal inserting subspace to guide the insertion of the male connector in the inserting direction, enabling the male connector to respectively enter the first female minor internal inserting subspace and the second female minor internal inserting subspace and be inserted into the fifth female terminal and the sixth female terminal, respectively.

6. The female connector of claim 5, wherein the first female minor inserting guiding structure comprises a T-shaped cross-section.

7. The female connector of claim 5, wherein the third female core lateral inner wall and the second female core longitudinal outer wall or the third female core longitudinal outer wall are substantially perpendicularly intersected.

8. The female connector of claim 5, wherein the female insulation core comprises a lateral extension plane, the first female core lateral inner wall, the second female core lateral inner wall, and the third female core lateral inner wall extend along the lateral extension plane, and the lateral extension plane is substantially perpendicularly intersected with the first female core longitudinal outer wall, the first female core longitudinal inner wall, the second female core longitudinal outer wall, and the third female core longitudinal outer wall.

9. The female connector of claim 1, wherein the female conductive terminal set further comprises a fifth female terminal and a sixth female terminal, and the female insulation core further comprises a third female core longitudinal outer wall, wherein the third female core longitudinal outer wall extends longitudinally and is respectively connected to the first female core lateral outer wall and the second female core lateral outer wall, thereby forming a female core minor internal inserting space; wherein,
the female insulation core is further mated with the fifth female terminal and the sixth female terminal, allowing the fifth female terminal and the sixth female terminal to respectively extend into the female core minor internal inserting space; and
the female core minor internal inserting space guides the insertion of the male connector in the inserting direction, enabling the male connector to enter the female core minor internal inserting space and be inserted into the fifth female terminal and the sixth female terminal.
